(19) United States
(12) Patent Application Publication
(10) Pub. No.: US 2018/0112729 A1
(43) Pub. Date: Apr. 26, 2018

(54) ACTUATOR

(71) Applicant: SAF-HOLLAND GmbH, Bessenbach (DE)

(72) Inventors: Olaf Drewes, Aschaffenburg (DE); Oliver Marschner, Haibach (DE)

(73) Assignee: SAF-HOLLAND GmbH, Bessenbach (DE)

(21) Appl. No.: 15/567,298

(22) PCT Filed: Apr. 18, 2016
(86) PCT No.: PCT/EP2016/058503

§ 371 Date: Oct. 17, 2017

(30) Foreign Application Priority Data
Apr. 20, 2015 (DE) 102015207099.9

(51) Int. Cl. F16D 65/09; F16D 65/22

(52) U.S. Cl. CPC F16D 65/09; F16D 2125/582; F16D 65/22

(57) ABSTRACT

This relates to an actuating unit, in particular for a drum brake, comprising a spacer element which can be fixed on a shoe unit or on a supporting unit, the spacer element having a holding section, via which it can be secured against movement along an activating axis relative to the shoe unit or the supporting unit, the spacer element having a first engagement section which is supported on the respective other one of the units comprising the shoe unit or the supporting unit in a first position of the spacer element, it being possible for the spacer element to be moved into a second position, in which the first engagement section is out of engagement with the shoe unit and the supporting unit, the spacer element spacing the shoe unit and the supporting unit further apart from one another in the first position than in the second position.

### BACKGROUND OF THE INVENTION

The present application relates to an actuating unit for use in brake systems, in particular for commercial vehicles, and to a method for dismantling a brake system.

Actuating units are known in the field of brake systems for commercial vehicles; it has thus proven advantageous to use adjusting and resetting devices in the brake actuating systems of commercial vehicles, which adjusting and resetting devices compensate for the wear of the brake shoes or the brake linings and can be reset again into the original starting position by way of the resetting function during the replacement of the brake linings. In the case of the actuating units which are known from the prior art, it has been necessary up to now to utilize the sometimes very complicated restoring mechanism which can be difficult to reach in order to dismantle the brake shoes, in order for it to be possible to set a sufficient play, by way of which the brake shoes or the brake linings can be removed from the brake end position. In the case of the known mechanical adjusting devices, in particular, the actuating screws of the actuating unit can often be reached only with great difficulty, and it is therefore difficult and time-consuming for a user to dismantle brake shoes and brake linings from brake units.

It is an object of the present invention to specify an actuating unit, by means of which dismantling of brake linings or brake shoes from a brake system is made possible, which dismantling is particularly simple, time-saving and associated with few working steps.

### SUMMARY OF THE INVENTION

According to the invention, the actuating unit comprises a spacer element which can be fixed on a shoe unit or on a supporting unit, the spacer element having a holding section, via which it can be secured against movement along an activating axis relative to the units comprising the shoe unit or the supporting unit, the spacer element having a first engagement section which is supported on the respective other one of the shoe unit or supporting unit in a first position of the spacer element, it being possible for the spacer element to be moved into a second position, in which the first engagement spacing is out of engagement with the shoe unit and the supporting unit, the spacer element spacing the shoe unit and the supporting unit further apart from one another in the first position than in the second position. The actuating unit is preferably a subassembly of a drum brake of a commercial vehicle or preferably of a disk brake of a commercial vehicle. Here, a spacer element is advantageously arranged in the force transmission region or in the supporting region between a shoe unit and a supporting unit, and is fixed on one of the units. The shoe unit is advantageously the brake shoe of a drum brake. The supporting unit is preferably a component or a structural unit which applies the activating force for activating the shoe unit or absorbs it from a further structural group of the brake system and transmits it to the shoe unit. The supporting unit is particularly preferably a piston of an expansion wedge unit. As an alternative, the supporting unit can preferably be a roller body or anti-friction body which absorbs the activating force from a hydraulic brake system or an expansion wedge unit and forwards it to the shoe unit. It is advantageous within the context of the present invention to allow the spacer element to act on the supporting unit which is at the same time also the activating unit or is directly in engagement with the activating unit, since in this way the systems which are required for the setting and activating of the brake are combined. As a result of the combination of the corresponding structural groups, a user can very easily perform the assembly, dismantling, setting and monitoring of the function of the brake and the actuating unit. Here, the spacer element is preferably arranged at least in its first position in such a way that it transmits the force which is applied by the supporting unit to the shoe unit and at the same time spaces the shoe unit apart from the supporting unit. Here, the spacer element can advantageously be moved from the first position with only a few manipulations or particularly preferably a single manipulation by way of a user into a second position, in which the first engagement section of the spacer element is not in engagement with the shoe unit and the supporting unit and therefore also does not space the shoe unit apart from the supporting unit. The spacing between the shoe unit and the supporting unit is advantageously reduced by way of the adjustment of the spacer element from the first position into the second position. In this way, a clearance between the shoe unit and the accordingly corresponding brake drum or brake disk of a brake system is increased by way of simple movement or rotation of the spacer element in a simple way, with the result that a sufficient play is possible for dismantling of the brake linings, the brake shoe or the accordingly corresponding components of the shoe unit.

The spacer element can advantageously be moved from the first position into the second position and from the second position back into the first position by way of rotation about an actuating axis and/or by way of movement along the actuating axis. In other words, the spacer element is therefore preferably secured against the rotational directions and movement directions which do not serve to move the spacer element from the first position into the second position and vice versa. In the second position, a second engagement section is preferably in engagement with the respective corresponding geometry which was in engagement with the first engagement section in the first position. Here, the spacer element can particularly preferably be moved from the first position into the second position and vice versa by way of a rotation of by way of a simple transversal movement, with the result that only as small a movement as possible of the spacer element is required by way of a user of the actuating unit, in order to provide the corresponding necessary clearance for dismantling the shoe unit. The first axis is preferably oriented in such a way that it is particularly easily possible for a user to move the spacer element from the first position into the second position in the brake system which is still assembled. In the case where the spacer element can be moved from the first position into the second position by way of transversal movement along the actuating axis, the actuating axis is therefore preferably arranged in the brake system in such a way that it points toward the user, it being possible for the user to move the spacer element into the second position by way of simple pulling or pushing of the spacer element toward him/her or away from him/her.

The first engagement section preferably has a greater mean extent along or parallel to the activating axis than a mean extent of a second engagement section of the spacer element along or parallel to the activating axis. Here, the activating axis is preferably the axis, along which the force is transmitted from the supporting unit to the shoe unit. At the same time, the activating axis is preferably the axis, along which the spacing between the supporting unit and the shoe unit is measured. Here, the spacer element preferably has a greater extent in the first engagement section than in the second engagement section, in order for it to be possible to produce a greater spacing between the shoe unit and the supporting unit in the first position than in the case of an engagement of the second engagement section in the second position of the spacer element. In the present case, the mean extent is preferably defined as the mean value of the extent along or parallel to the activating axis of the respective engagement section, which is relevant, in particular, in the case of rounded or elliptically formed cross-sectional geometries of the engagement sections. It is possible here that, during operation of the brake system, the first engagement section or the second engagement section transmits a force in each case to the shoe unit or the supporting unit with slightly different sections, depending on the position of the supporting unit and the shoe unit with respect to one another. Here, rounded geometries in the region of the engagement sections and the corresponding contact geometries of the shoe unit and the supporting unit are particularly preferred, since stress concentration, tilting and locally occurring Hertzian surface stress by way of excessively small force-transmitting cross-sectional areas can be avoided.

The second engagement section of the spacer element is preferably supported on the shoe unit or the supporting unit in the second position. The spacer element is fixed on one of the units comprising the shoe unit or the supporting unit. Here, in the second position, a second engagement section is preferably supported on that one of the two units, on which the spacer element is not fixed. As an alternative to this, the spacer element might not have a second engagement section, the shoe unit and the supporting unit bearing directly against one another in the second position of the spacer element, and no engagement section of the spacer element directly transmitting a force from the supporting unit to the shoe unit. The spacer element is nevertheless also fixed in this case on one of the two units comprising the shoe unit or the supporting unit in the second position.

A securing section is further preferably provided which secures the spacer element in the first position against rotation about the actuating axis and/or against movement along the actuating axis relative to the supporting unit or to the shoe unit. In a first preferred embodiment, the securing section can be arranged on a separate element and can be brought into corresponding engagement with the spacer element and preferably one or both of the units comprising the shoe unit or the supporting unit, in such a way that it secures the spacer element in the first position. Here, in particular, the securing section secures the spacer element against the corresponding displacement movement or rotational movement which would move the spacer element into the second position. If a rotation about the actuating axis is therefore required, in order to move the spacer element from the first position into the second position, the securing section thus secures the spacer element precisely against said rotation. In further alternative preferred embodiments, the securing section can be arranged on a securing element which is configured as a securing pin, it being possible for the securing pin to be brought into engagement in a cutout of the spacer element and/or of one or both units comprising the shoe unit or the supporting unit.

Furthermore, the spacer element preferably has a grip face which facilitates or makes possible the manual movement or rotation of the spacer element by a user. Here, the grip face of the spacer element is preferably provided with scores or grooves which are of particularly anti-slip nature. Here, the grip face is preferably provided on the outer edge of a spacer element which is, for example, of disk-shaped configuration or of cylindrical configuration in regions, with the result that the user can move the spacer element with one hand from the first position into the second position, without tools being necessary in the process. In this way, the dismantling and maintenance work on the brake system having an actuating unit according to the present invention are particularly simplified.

A movement of the spacer element from the first position into the second position advantageously brings about or makes possible a change in the spacing of the shoe unit from the supporting unit along the activating axis. Here, the spacing between the shoe unit and the supporting unit is preferably measured in the region of the contact between the shoe unit or the supporting unit with the respective section which can be brought into engagement with the first engagement section of the spacer element. In other words, therefore, if, for example, the supporting unit is supported on the first engagement section of the spacer element in the first position, the spacing between the supporting unit and the shoe unit, preferably the spacing of the accordingly corresponding face of the supporting unit which passes into engagement with the first engagement section from an accordingly corresponding reference geometry on the shoe unit, is along or parallel to the activating axis. Since the change in the spacing takes place along or parallel to the activating axis, the movement of the spacer element from the first position into the second position therefore has precisely the same effect as the much more complicated resetting of the activating unit by way of rotation of the thread or a motor of an adjusting device of a brake. In this way, the spacer element can be utilized to take over part of the resetting action by way of an adjusting unit of the brake system.

The change in the spacing particularly preferably lies in the range from 1 mm to 2 cm, preferably from 2 mm to 1 cm, and particularly preferably at from approximately 4 mm to 6 mm. Here, the greatest of the preferred ranges for the spacing of from 1 mm to 2 cm comprises all brake systems which have been tested within the context of the present invention. In the case of a change in the spacing of less than 1 mm, the advantage of the invention that shoe units can be dismantled from the brake system with few manipulations cannot be ensured unreservedly. In the case of a change in the spacing of more than 2 cm, the force which is to be applied by the user to also transmit said change in the spacing by way of the movement of the spacer element to the shoe units is very great and cannot be carried out unreservedly and without additional tools by all users. The preferred range of from 2 mm to 1 cm has been particularly proven for drum brakes of commercial vehicles, since the lower limit of 2 mm and the upper limit of 1 cm make a particularly simple dismantling capability possible, in particular for said brake systems, with only moderate forces which can be managed easily by a user. In particular, the range of from 4 mm to 6 mm is preferred, in the case of which all of the embodiments which are proposed within the context of this invention can preferably be moved equally easily from the first position into the second position and vice versa, and a sufficient assembly freedom or sufficient play of the shoe units can be achieved at the same time. Said particularly preferred range of from 4 mm to 6 mm represents the best compromise between sufficient play for dismantling and low forces which have to be applied by the user.

The spacer element particularly preferably has a third engagement section which can be brought into positively locking engagement with the securing section. The third engagement section of the spacer element is preferably configured as a bore or groove, it being possible for a securing section which is provided on a securing ring or circlip to engage into the corresponding groove, whereas an engagement section which is configured as a bore is designed for the engagement of a securing section which is configured on a pin or securing peg. The third engagement section is advantageously configured on the spacer element in such a way that a commercially available body, such as a circlip, can be configured with the securing section, in order to protect the spacer element against movement and to hold it in the first position. The costs for an actuating unit within the context of the present invention can therefore be reduced considerably.

Moreover, the securing section is preferably configured on a clip element which, having been brought into positively locking engagement with the shoe unit, secures the spacer element against rotation about the actuating axis. The clip element can preferably be configured as a U-shaped body which firstly has engagement faces for positively locking engagement with the spacer element and secondly also preferably has engagement faces for positively locking engagement with an accordingly corresponding geometry of the shoe unit, in order to particularly preferably secure the spacer element against rotation about the actuating axis relative to the shoe unit. In particular, an undercut geometry can preferably be provided on the clip element, which undercut geometry can be overcome by a user with the application of a force which can be generated manually, in order for it to be possible to “clip” the clip element with the securing section into the corresponding securing position, and in order for it also to be possible to remove it from said position again without a further tool.

As an alternative, the securing section can preferably be fixed on the spacer element or can be configured in one piece with the spacer element, and can have a geometry which differs from the rotational geometry in relation to the actuating axis, it being possible for the securing section to be moved by way of movement along the actuating axis into a position, in which it engages in a corresponding section on the shoe unit and secures the spacer element against rotation about the actuating axis. As an alternative or in addition to a securing section which is configured on a separate element, the securing section can also be configured as a geometry on the spacer element, which geometry correspondingly differs from the rotational geometry. Here, for example, an external square which is simple to produce may be suitable, which external square can be brought into engagement with a corresponding section of the shoe unit, which section is configured as an internal square bore, the spacer element being secured against rotation about the actuating axis relative to the shoe unit. It goes without saying that, as an alternative to the spacer element being fixed on the shoe unit, securing of the spacer element on the supporting unit is also possible by way of a correspondingly configured securing section.

Furthermore, a holding element is preferably provided, in order to secure the securing section against movement along the actuating axis. In the case, in particular, in which the securing section is configured to secure the spacer element against rotation about the actuating axis, a holding element, such as a splint or a clamping ring, is preferably provided which prevents the securing section from sliding out of the position, in which it secures the spacer element against rotation relative to the shoe unit. The advantage of said embodiment is that the holding element has to absorb only relatively low forces, since the main load of the securing action is assumed by the securing section itself, and the holding element prevents the securing section from sliding out of the position, in which it secures the spacer element in its first position, in the case of vibrations during operation. The holding element can therefore be of particularly small and light configuration, as a result of which weight and costs can be saved.

A rotation of the spacer element about an angle particularly preferably moves the spacer element from the first position into the second position or vice versa, the angle being smaller than 360°, preferably ≤180°, and particularly preferably ≤90°. The spacer element can particularly preferably be moved from the first position into the second position by way of few manipulations; complicated screwing of the spacer element which requires a plurality of revolutions is to be avoided, in particular. It is accordingly one preferred feature of the spacer element that it can be moved from the first position into the second position by way of rotation by an angle of <360°. This is a significant difference from the possibilities known up to now from the prior art of producing a corresponding mounting and dismantling play for a shoe unit. There, the adjusting or resetting unit is reset, or screwed back, using the existing thread, rotational angles of frequently considerably more than 720° being necessary for it to be possible to establish a sufficient play. The required angle, about which the spacer element has to be rotated, in order to be moved from the first position into the second position, is particularly preferably less than or approximately 180°, which is possible for a user using a single grip. The angle of 180° can have advantages in comparison with the angle of 90°, however, since a gradual transition can be achieved between the first position and the second position and vice versa, by, for example, bevels and chamfers which are provided over a relatively long angular range being present. This facilitates the movement of the spacer element from the second position back into the first position, in which the forces which usually act on the shoe units have to be overcome. The angle is particularly preferably less than or equal to 90°, it being possible for the user to establish a sufficient mounting play for dismantling the brake shoes by way of merely very small rotation of the spacer element by means of a simple lever element which can be attached, for example, on the spacer element and makes it easier to apply the required force.

The first engagement section is particularly preferably configured as a rectangular projection, the long edge of which has a greater extent than the spacing of two shoe webs of the shoe unit, the short edge of the first engagement section having a smaller extent than the spacing of the shoe webs from one another. In this way, the spacer element can be arranged in the first position in such a way that the long edge extends substantially perpendicularly with respect to the shoe webs, both shoe webs preferably coming to lie at the first engagement spacing. If the spacer element is moved into the second position, it is preferably rotated by 90° in such a way that the short edge of the first engagement section is now situated between the shoe webs, and the first engagement section is therefore not in engagement with the shoe webs. If the spacer element is moved into the second position, it is preferably rotated by 90° in such a way that the short edge of the first engagement section is now situated between the shoe webs, and the first engagement section is therefore not in engagement with the shoe webs. In other words, during the rotation of the spacer element from the first position into the second position, the first engagement section slides between the shoe webs, the shoe webs in the second position either coming into contact on a second engagement section of the spacer element or directly on the supporting unit. In this preferred case, a rotation of the spacer element by 90° is therefore sufficient to achieve the corresponding play for dismantling of the shoe unit.

Furthermore, the spacer element is preferably fixed on an activating piston of the supporting unit, the activating axis running parallel to the actuating axis. Here, the spacer element is advantageously preferably configured in one piece with the activating piston, it being necessary merely for the activating piston to be rotated by an angle of preferably less than 180° in order to move the spacer element from the first position into the second position. As a result of the integration of the spacer element on the activating piston, it is possible in a particularly simple way to integrate the actuating unit of the present invention into brake systems which already exist, by a corresponding geometry which is configured as a spacer element being joined simply to the activating pistons which are provided there. As an alternative, the spacer element can also preferably be fixed on the activating piston via a corresponding geometry which engages in a positively locking manner. It is also particularly simply possible in this way to subsequently retrofit the spacer element into brake systems which already exist. As an alternative, the spacer element might also be arranged on that engagement geometry of a brake shoe which lies opposite the activating unit of the brake, such as a ball socket which is provided on the opposite side of the brake for mounting the brake shoe. In one preferred embodiment, an actuating unit having a spacer element can be arranged both on the activating unit and on the ball socket of a drum brake.

The supporting unit preferably comprises a roller body of cylindrical or barrel-shaped configuration which is supported with its circumferential face on an expansion wedge unit of the supporting unit, the spacer element being of pin-shaped configuration in regions and engaging on the shoe unit with its first engagement section in the first position and with its second engagement section in the second position, the holding section of the spacer element being supported in a cutout of the supporting unit, in particular in a cutout on the roller body of the supporting unit. Here, the spacer element particularly preferably has sections of different diameter, in each case the sections having the greater diameter being in engagement in the first position of the spacer element as first engagement sections with a corresponding holding geometry on the shoe unit. In the second position of the spacer element, the second engagement sections of the spacer element which have a smaller diameter than the first engagement sections preferably engage on the shoe unit. A user can move the spacer element along the actuating axis in a particularly simple way and thus move the spacer element from the first position into the second position and vice versa in a particularly simple way, by the spacer element being configured as a simple pin with different engagement sections of different diameter. Here, in the first position, the spacer element can be secured against movement along the actuating axis by way of a simple circlip, as described above.

The spacer element can advantageously be moved from the first position into the second position and vice versa by way of movement along the actuating axis. In said preferred case, a movement of the spacer element along the actuating axis can be carried out very simply for a user, since said movement can take place laterally in relation to the wheel rotational axis of the wheel which is fixed on the brake system. Therefore, the spacer element can be reached particularly satisfactorily from the outside during dismantling of the brake system, and the displacement movement along the actuating axis can also be carried out particularly simply by a user. In comparison with a rotation of the spacer element about the actuating axis, the user does not have to apply a torque in the case of a movement of the spacer element, but rather can readily reach the second position of the spacer element, even in the case of a jammed spacer element, for example by way of the use of a hammer. In the case of highly loaded brake systems in commercial vehicles or agricultural commercial vehicles, in particular, the configuration of the spacer element in such a way that it can be moved from the first position into the second position by way of movement along or parallel to the actuating axis is therefore a more robust configuration of the actuating unit, since the required play for dismantling the shoe unit can nevertheless be established in the case of jamming of the spacer element as a result of dirt, rust or similar states which are typical for commercial vehicles of this type.

In one alternative embodiment, the spacer element can be moved from the first position into the second position and vice versa by way of rotation about the actuating axis. Here, the rotation of the spacer element can preferably be facilitated, in particular, by way of the provision of an external hexagon geometry on the spacer element, which external hexagon geometry can be brought into engagement, for example, with an open-end wrench, as a result of which it becomes particularly easy for the user to apply the required torque for moving the spacer element from the first position into the second position and vice versa. It is the advantage in the case of said embodiment that, in particular, the movement of the spacer element from the second position back into the first position is just as simple as the movement of the spacer element from the first position into the second position.

The spacer element particularly preferably has a bevel which is arranged between the first engagement section and the second engagement section. In particular, the transition of the spacer element between the first position and the second position is facilitated by way of the bevel between the first engagement section. Here, the bevel allows it to be unnecessary for a separate force to be used on the shoe unit or the supporting unit, in order to move them into a position relative to one another, in which the spacer element can be moved back into the first position. Here, in particular, the oblique geometries are preferably designed in such a way that, if a defined force which preferably can still be applied manually is overcome, the spacer element spaces the shoe unit and the supporting unit apart from one another in such a way that no further force is required, in order to move the actuating unit from the second position back into the first position.

In a particularly advantageous method, a brake system can be dismantled within the context of the present invention. Here, the method comprises the steps: releasing of a securing section out of its engagement with a spacer element, rotating and/or moving of the spacer element about and/or along an actuating axis in such a way that the spacer element passes from a first position into a second position, utilizing of the play which is produced on a shoe unit, in order to dismantle the shoe unit. Here, the capability to carry out the method for dismantling the shoe unit from the brake system is permitted, in particular, by the nature of the spacer element. The spacer element preferably makes particularly rapid dismantling of the brake shoes possible by way of a single rotation and/or movement of the spacer element. Within the context of the present invention, the spacer element is preferably rotated merely by an angle of less than or equal to 180°, in order to pass from the first position into the second position. It goes without saying that the above-described features of the actuating unit can also form features of the method for dismantling a brake system, if they directly influence and advantageously aid its practicability.

### BRIEF DESCRIPTION OF THE DRAWINGS

Further advantages and features of the present invention result from the following description of preferred embodiments with reference to the appended figures. It goes without saying that individual features of the preferred embodiments which are described in the individual exemplary embodiments can also be used in embodiments of other examples and other figures, if this has not been ruled out explicitly or is prohibited on the basis of technical circumstances. In the figures:

FIG. 1 shows the views of a first preferred embodiment of the actuating unit according to the invention;

FIGS. 2a, b, c show views of three preferred embodiments of the spacer element according to the invention;

FIG. 3 shows two views of a further preferred embodiment of the actuating unit according to the invention;

FIGS. 4a, b show two views of one preferred embodiment of the actuating unit according to the invention; and

FIGS. 5a, b show two views of one preferred embodiment of the actuating unit according to the invention.

### DETAILED DESCRIPTION OF THE PREFERRED EMBODIMENTS

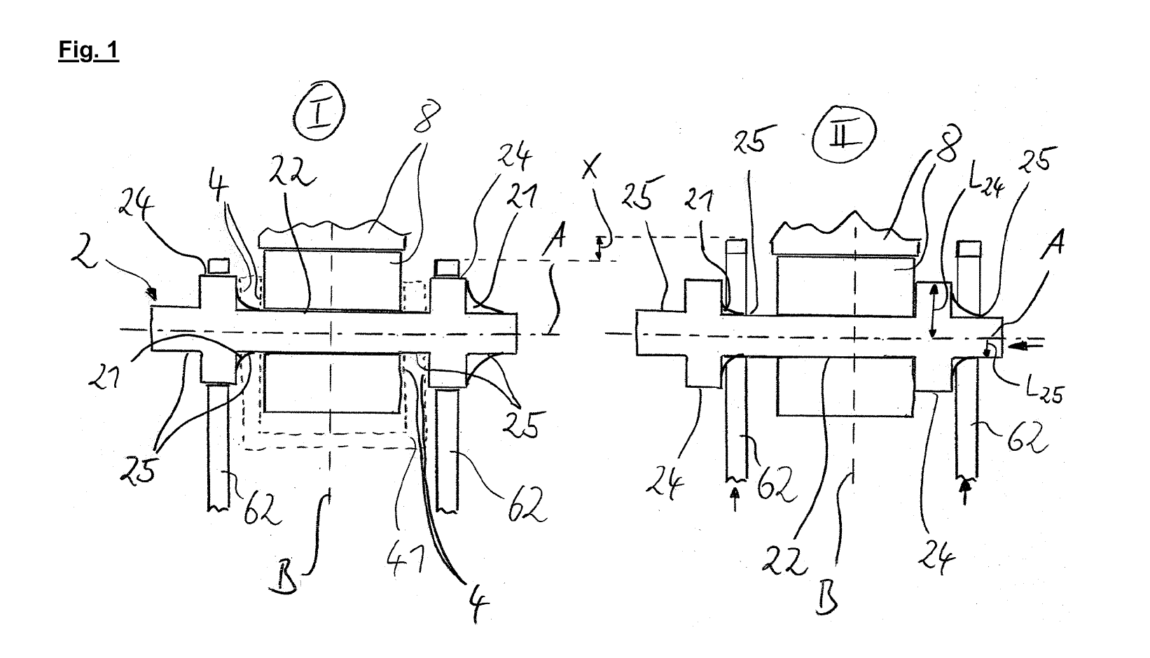

FIG. 1 shows two views of one embodiment of the actuating unit according to the invention, the left-hand part (identified by I) of FIG. 1 showing the actuating unit in the state, in which the spacer element 2 is situated in its first position I. The view on the right which is identified by II shows the spacer element 2 in its second position II. The spacer element 2 has a first engagement section 24 and a second engagement section 25. As shown in the preferred embodiment, the spacer element 2 preferably has two first engagement sections 24 and four second engagement sections 25. Furthermore, the spacer element 2 preferably has a holding section 22 which preferably has the same diameter in the present embodiment as the second engagement sections 25. The shoe unit 6 preferably comprises two shoe webs 62 which are provided with cutouts which can be brought into engagement in each case with the first engagement section 24 or with a second engagement section 25 of the spacer element 2. In the first position I, the shoe unit 6 or the shoe webs 62 is/are in engagement with the first engagement sections 24. A dashed line shows one preferred clip element 41 which has securing sections 4 which secure the spacer element 2 in the first position I. After the clip element 41 is released, the spacer element 2 can be displaced along the actuating axis A in such a way that the first engagement sections 24 pass out of engagement with the shoe unit 6. Finally, the spacer element 2 can be moved into its second position II, the shoe unit 6 or the shoe webs 62 being in engagement with the second engagement sections 25 of the spacer element in the second position. The second engagement sections 25 have a smaller extent L₂₅ transversely with respect to the actuating axis or along an activating axis B than the first engagement sections 24. This difference of the extent L₂₄ of the first engagement sections from the extent L₂₅ of the second engagement sections 25 therefore defines the change in spacing x, by which the shoe unit 6 moves closer to the supporting unit 8 or moves along or parallel to the activating axis B in the direction of the supporting unit 8. In the embodiment which is shown in FIG. 1, a play (not shown) is preferably produced on the underside of the shoe unit 6 in the second position II of the spacer element 2. It goes without saying that, starting from the first position I, the spacer element might also be moved to the right, in order to be moved into the second position II. This allows, in particular, it to be possible for an actuating unit in accordance with the embodiment which is shown in FIG. 1 to be used both on right-hand side and left-hand side brake systems on the chassis of a commercial vehicle, without structural modifications being necessary. Bevels 21 are preferably provided in the transition region between the first and the second engagement section 24, 25, in order to facilitate the movement of the spacer element 2 from the second position II back into the first position I.

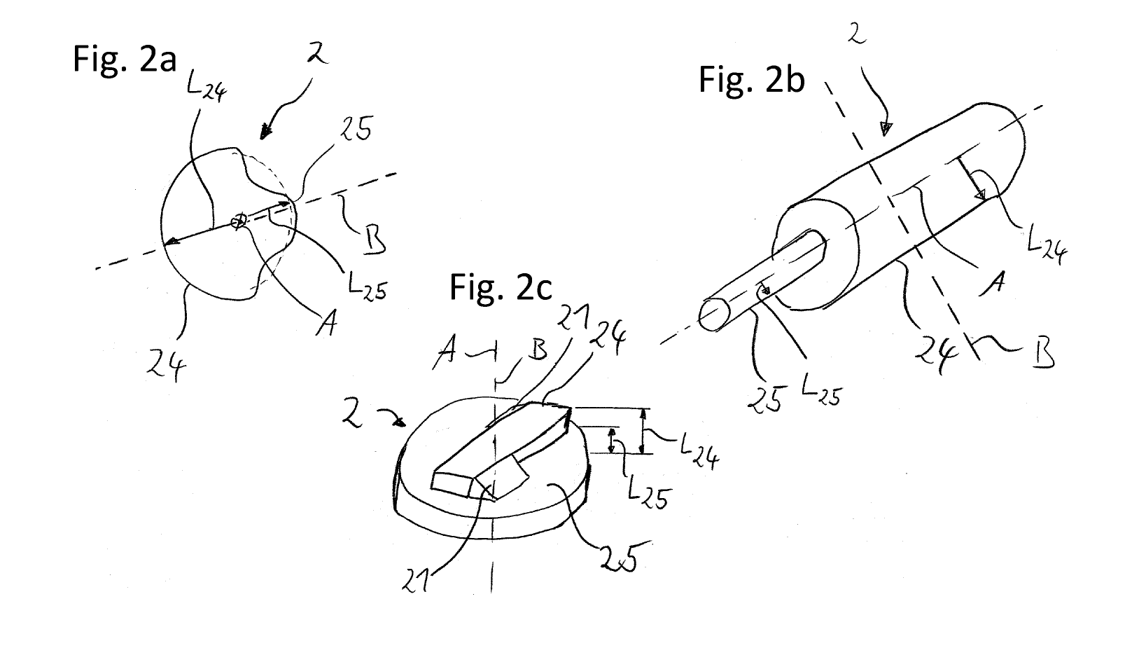

FIG. 2a shows one preferred embodiment of the spacer element 2 according to the invention, in the case of which it is of pin-shaped configuration and has a first engagement section 24 which has a greater extent along or parallel to the activating axis B than a second engagement section 25. In the case of the substantially cylindrical configuration (shown in the present example) both of the first engagement section 24 and of the second engagement section 25, said extent L₂₄ and L₂₅ of the engagement sections 24, 25 is substantially their radius or the radius of the cylindrical circumferential face. In order to be moved from the first position I into the second position II, the spacer element II is preferably moved along the actuating axis A which is shown. In particular, the actuating axis A preferably lies orthogonally or perpendicularly with respect to the activating axis B in said embodiment.

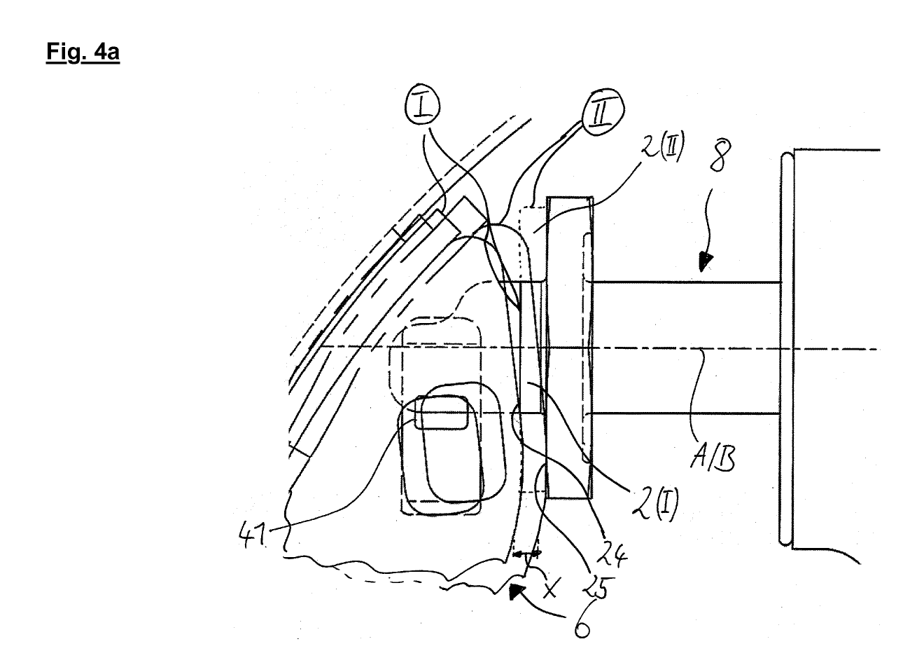

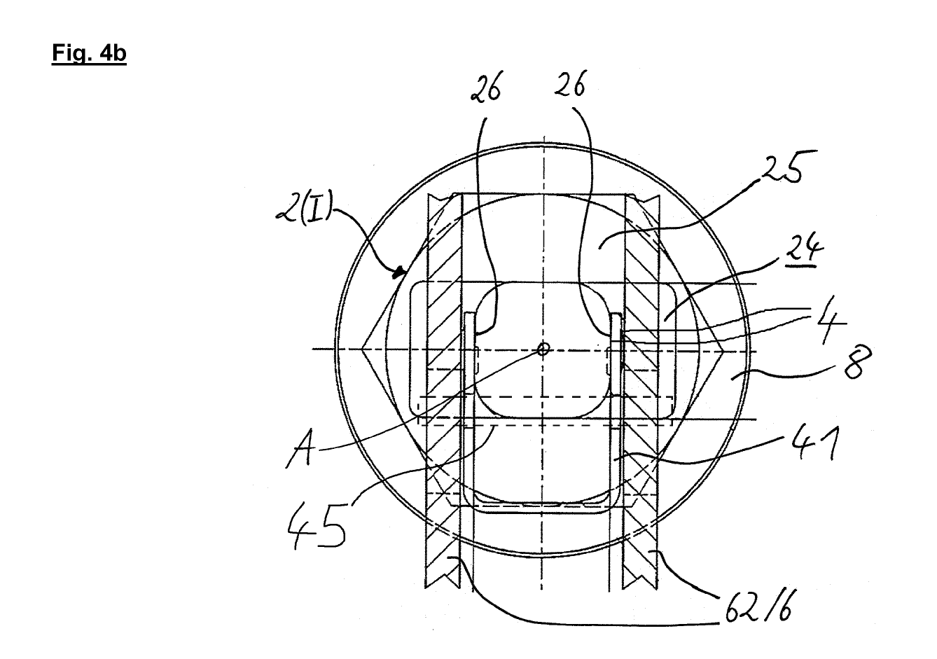

FIG. 2b shows a second preferred embodiment of the spacer element 2 according to the invention, in the case of which it has a disk-shaped section, on which a first, substantially rectangular first engagement section 24 is configured. In the region of the first engagement section 24, the spacer element 2 has a greater extent L₂₄ along or parallel to the activating axis B than in the region of the second engagement section 25. As is also shown in FIGS. 4a and b, a shoe unit 6 therefore preferably passes into engagement with the first engagement section 24 of rectangular configuration in the first position of the spacer element 2, and into engagement with the second engagement section 25 in the second position II. It goes without saying that, in the present case, the actuating axis A, about which the spacer element 2 is rotated in order to be moved from the first position I into the second position II, is congruent or parallel to the activating axis B, along which the supporting unit 8 and the shoe unit 6 (both not shown) are spaced apart from one another to a greater or lesser extent.

Finally, FIG. 2c shows a third preferred embodiment of the spacer element 2 according to the invention, said spacer element 2 being of substantially disk-shaped configuration and having a first engagement section 24 which corresponds to half a cylindrical face, and a second engagement section 25 which has an outer face which differs from the cylindrical shape of the first engagement section 24. Here, the mean extent L₂₄ of the first engagement section 24 is greater than the mean extent L₂₅ of the second engagement section 25 along or parallel to the activating axis B. In the present case, the spacer element 2 is arranged with respect to the activating axis B in such a way that the activating axis B intersects the corresponding engagement sections 24, 25 in each case in the face, in which, during use of the spacer element 2 in the first position I and in the second position II, the shoe unit 6 or the supporting unit 8 comes into contact. The distinction or the difference of the extents L₂₅ and L₂₄ therefore defines the change in the spacing of the shoe unit 6 from the supporting unit 8 if the spacer element 2 is moved into the second position II.

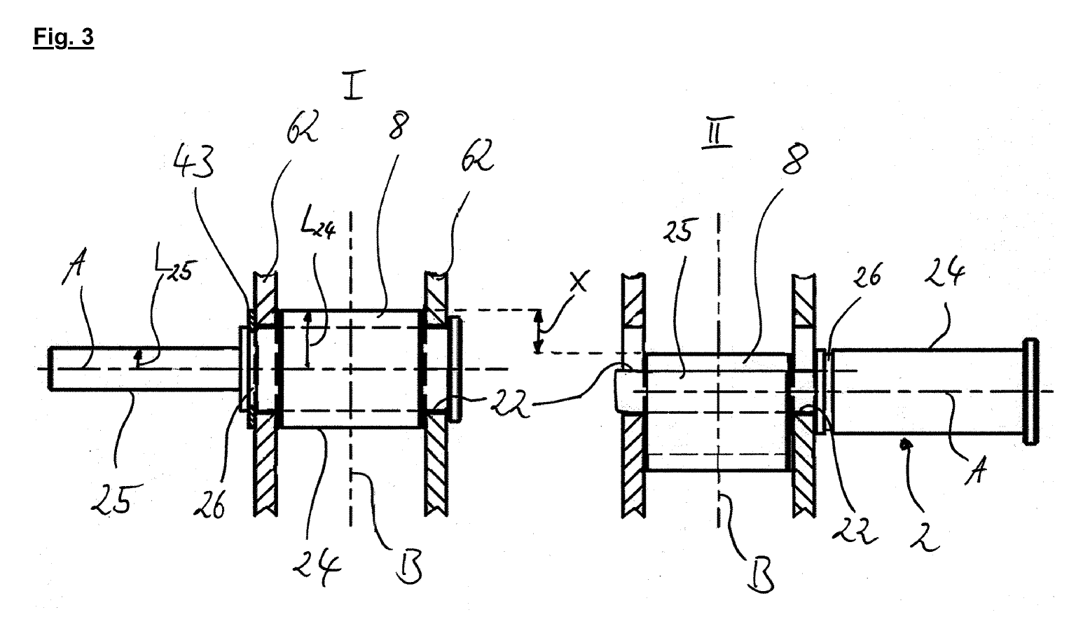

FIG. 3 shows a further preferred embodiment of the actuating unit according to the invention which is substantially very greatly similar to the embodiment which is shown in FIG. 1. Furthermore, the embodiment which is shown in FIG. 3 corresponds substantially to the embodiment which is shown in FIG. 2a, it being possible to see further details. The shoe unit 6 preferably has two shoe webs 62 which are in engagement with a first engagement section 24 of the spacer element 2 in the first position I and with the second engagement section 25 of the spacer element 2 in the second position (see the right-hand side in the figure). In the present case, the supporting unit 8 preferably comprises a supporting roller, the internal diameter of which in each case likewise passes into engagement with the first engagement section 24 or with the second engagement section 25. In this way, in the case of a single difference of the extents L₂₄ and L₂₅ with respect to one another, twice said difference becomes relevant as a change in the spacing x of the supporting unit 8 from the shoe unit 6. In other words, both the spacer element 2 moves relative to the shoe unit 6 by the respective difference of the extents L₂₄ and L₂₅ and, at the same time, the roller element of the supporting unit 8 also moves relative to the spacer element 2 by the magnitude of the difference of the extents L₂₄ and L₂₅. In the first position I (shown on the left in FIG. 3), the second engagement section 25 which protrudes out of the actuating unit in the present case can preferably be used as a wear indicator, by a corresponding scale being provided on the housing of the brake unit and the second section 25 which protrudes from the brake shoes being used as a pointer. Furthermore, a clamping ring 43 is preferably provided which has a securing section 4 and engages in the third engagement section 26, in order to secure the spacer element 2 in the first position I and to prevent a movement of the spacer element 2 along the actuating axis A relative to the shoe unit 6, at least relative to one of the shoe webs 62 in the present case.

FIG. 4a shows a further preferred embodiment of the actuating unit 4 according to the invention, both the first position I and the second position II being shown in the figure in a superimposed way. Furthermore, FIG. 4b shows a view along the activating axis B of the embodiment which is shown in FIG. 4a for illustrative purposes. The spacer element 2 is preferably an integral constituent part of an activating piston of the supporting unit 8 which is configured as an activating unit of the brake system. With preference, furthermore, the spacer element 2 preferably has a first engagement section 24 which is of substantially rectangular configuration. As shown in FIG. 4b, the spacer element 2 can be secured in the first position I by way of a clip element 41 which prevents a rotation of the spacer element 2 about the actuating axis A. Here, the clip element 41 engages on at least a third engagement section 26 of the spacer element 2. Therefore, the securing sections 4 of the clip element 41 secure the spacer element 2 in the first position I against rotation about the actuating axis A by way of engagement on the third engagement sections 26 and on the inner sides of the shoe webs 62. The holding element 45 is shown diagrammatically, which secures the clip element 41 against movement relative to the spacer element 2 and/or to the shoe unit 6. After the holding element 45 and subsequently the clip element 41 have been removed, a user can rotate the spacer element 2 by 90° about the actuating axis A, as a result of which the first engagement section 24 is pushed between the shoe webs 62 of the shoe unit 6 and finally passes out of engagement with the shoe webs 62. In this state, the case which is shown in FIG. 4a and is identified by II is reached, in which the shoe unit 6, in particular preferably the shoe webs 62, is/are supported directly on the second engagement section 25 or lies/lie on the latter. A play between the brake linings and the brake drum which surrounds the actuating unit is produced as a result on the left-hand side of the brake shoe unit 6.

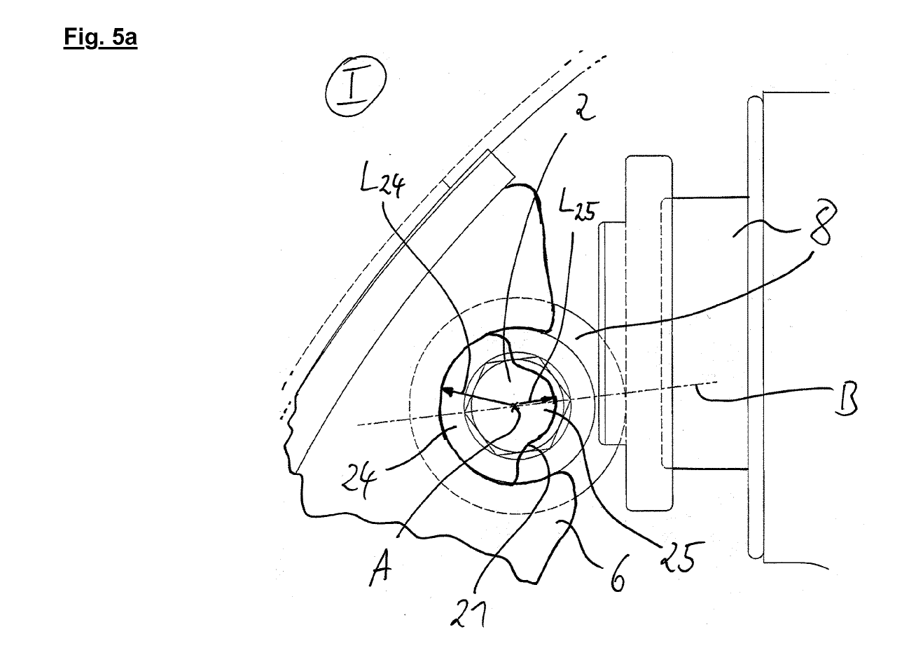

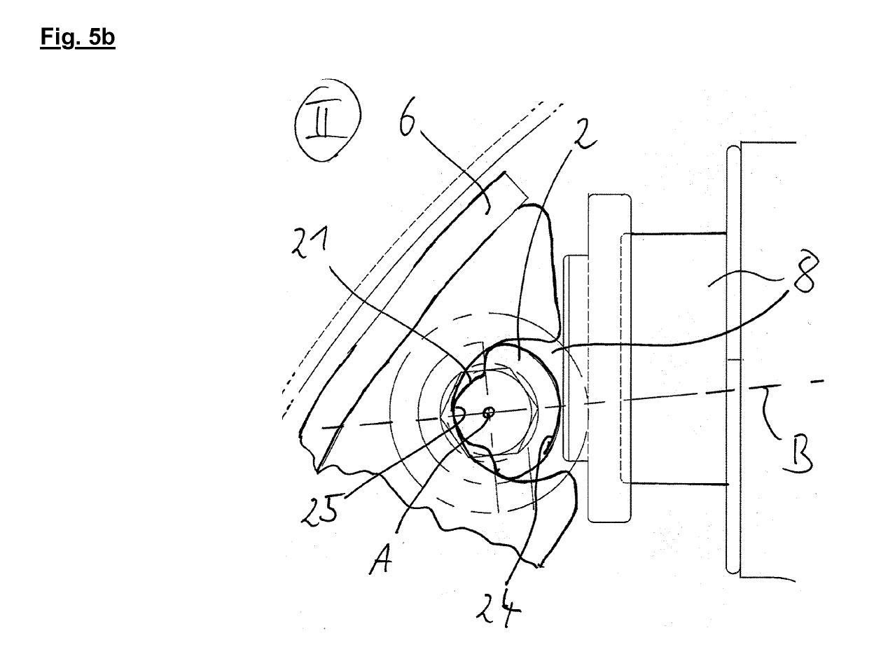

FIG. 5a and FIG. 5b show a further preferred embodiment of the actuating unit, in the case of which the spacer element 2 is preferably configured as in FIG. 2c. The spacer element 2 is preferably supported in a holding section 22 (not shown) on the supporting roller of the supporting unit 8. In the first position which is shown in FIG. 5a, the spacer element 2 engages here with its first engagement section 24 on the shoe unit 6 and spaces the latter apart with respect to the supporting unit 8, in particular with respect to the activating piston of the supporting unit 8. In the second position II which is shown in FIG. 5b, the spacer element has been rotated by approximately 180°, the second engagement section 25 now being in engagement with the shoe unit 6. As identified in FIG. 5a, the second engagement section 25 has a smaller extent L₂₅ along the activating axis B than the first engagement section 24. Therefore, in the second position II, the shoe unit 6 can move closer to the supporting unit 8, as a result of which a play or gap is produced between the shoe unit 6 and the surrounding brake drum. In the position which is shown in FIG. 5b, the shoe unit 6 can be dismantled easily. The rounded region between the first engagement section 24 and the second engagement section 25 is suitable as a bevel 21 within the context of the present invention, since it facilitates the rotation of the spacer element 2 about the actuating axis A.

### LIST OF DESIGNATIONS

2 Spacer element
21 Bevel
22 Holding section
24 First engagement section
25 Second engagement section
26 Third engagement section
4 Securing section
41 Clip element
43 Clamping ring
45 Holding element
6 Shoe unit
62 Shoe web
8 Supporting unit
82 Activating piston
A Actuating axis
B Activating axis
I First position
II Second position
x Change in the spacing
L₂₄ Mean extent of the first engagement section
L₂₅ Mean extent of the second engagement section

1.-15. (canceled)

16. An actuating unit, comprising:
a spacer element configured to be fixed on at least one of a shoe unit and a supporting unit, the spacer element having a holding section via which the spacer element is configured to be secured against movement along an activating axis relative to at least one of the shoe unit and the supporting unit, the spacer element having a first engagement section which is supported in a first position of the spacer element on the respective other one of the shoe unit and the supporting unit not secured by the holding section, wherein the spacer element is configured to be moved into a second position of the spacer element, where the first engagement section is out of engagement with the at least one of the shoe unit and the supporting unit; and
a second engagement section of the spacer element being supported on at least one of the shoe unit and the supporting unit in the second position, the spacer element spacing the shoe unit and the supporting unit further apart from one another in the first position than in the second position, wherein the spacer element is configured to be moved from the first position into the second position and from the second position into the first position by way of movement along an actuating axis, the actuating axis lying orthogonally with respect to the activating axis.

17. The actuating unit as claimed in claim 16, wherein the first engagement section has a greater mean extent along the activating axis than a mean extent of the second engagement section of the spacer element along the activating axis.

18. The actuating unit as claimed in claim 16, wherein a movement of the spacer element from the first position into the second position changes a spacing of the shoe unit from the supporting unit along the activating axis.

19. The actuating unit as claimed in claim 16, further comprising:
a securing section which secures the spacer element in the first position against at least one of rotation about the actuating axis and movement along the actuating axis relative to the supporting unit or to the shoe unit.

20. The actuating unit as claimed in claim 19, wherein the change in the spacing is within the range from 1 mm to 2 cm.

21. The actuating unit as claimed in claim 20, wherein the change in the spacing is within the range from 2 mm to 1 cm.

22. The actuating unit as claimed in claim 21, wherein the change in the spacing is within the range from 4 mm to 6 mm.

23. The actuating unit as claimed claim 16, wherein the spacer element has a third engagement section which is configured to be brought into a positively locking engagement with the securing section.

24. The actuating unit as claimed in claim 19, wherein the securing section is configured on a clip element which, having been brought into a positively locking engagement with the shoe unit, secures the spacer element against rotation about the actuating axis.

25. The actuating unit as claimed in claim 19, wherein the securing section is at least one of fixed on the spacer element and configured in one piece with the spacer element, the securing section having a geometry which differs from the rotational geometry in relation to the actuating axis, wherein the securing section is configured to be moved by way of movement along the actuating axis into a position in which the securing section engages into a corresponding section on the shoe unit securing the spacer element against rotation about the actuating axis.

26. The actuating unit as claimed in claim 16, wherein a rotation of the spacer element by an angle moving the spacer element between the first and second positions, wherein the angle is smaller than 360°.

27. The actuating unit as claimed in claim 26, wherein the angle is smaller than or equal to 180°.

28. The actuating unit as claimed in claim 27, wherein the angle is smaller than or equal to 90°.

29. The actuating unit as claimed in claim 16, wherein the first engagement section is configured as a rectangular projection, a long edge of the first engagement section having a greater extent than the spacing of two shoe webs of the shoe unit, and a short edge of the first engagement section having a smaller extent than the spacing of the shoe webs from one another.

30. The actuating unit as claimed in claim 29, the spacer element being fixed on an activating piston of the supporting unit, the activating axis running parallel to the actuating axis.

31. The actuating unit as claimed in claim 16, wherein the supporting unit comprises a roller body having cylindrical or barrel-shaped configuration which is supported with a circumferential face of the roller body on an expansion wedge unit of the supporting unit, and wherein the spacer element having a pin-shaped configuration in regions and engaging on the shoe unit with the first engagement section in the first position and with the second engagement section in the second position, the holding section of the spacer element being supported in a cutout of the supporting unit.

32. The actuating unit as claimed in claim 29, wherein the spacer element is configured to be moved between the first and second positions by way of rotation about the actuating axis.

33. A method for dismantling a brake system, comprising:
releasing a securing section out of engagement with a spacer element;
moving the spacer element along an actuating axis such that the spacer element passes from a first position into a second position; and
utilizing of a spacing which is produced on a shoe unit to dismantle the shoe unit, in order to dismantle the shoe unit.
